(19) United States
(12) Patent Application Publication
(10) Pub. No.: US 2026/0329267 A1
(43) Pub. Date: Oct. 22, 2026

(54) Method and Device for Explaining an Anomaly in a Time Series of a Manufacturing Process at least within a Time Window

(71) Applicant: Robert Bosch GmbH, Stuttgart (DE)

(72) Inventors: Johannes Haug, Rottenburg (DE); Eric Sebastian Schmidt, Moensheim (DE); Stefan Patrick Lindt, Ettlingen (DE)

(21) Appl. No.: 19/652,054

(22) Filed: Apr. 20, 2026

(30) Foreign Application Priority Data
Apr. 22, 2025 (DE) 10 2025 115 391.4

(51) Int. Cl. G05B 23/02

(52) U.S. Cl. CPC G05B 23/0264

(57) ABSTRACT

A method for explaining an anomaly in a time series to be explained of a manufacturing process at least within a time window is disclosed. The anomaly is detected by way of a detection model.

This application claims priority under 35 U.S.C. § 119 to patent application no. DE 10 2025 115 391.4, filed on Apr. 22, 2025 in Germany, the disclosure of which is incorporated herein by reference in its entirety.

The disclosure relates to a method and device for explaining an anomaly in a time series of a manufacturing process at least within a time window.

### BACKGROUND

Explainable Artificial Intelligence (XAI) is an increasingly important area of machine learning research, particularly in safety-critical applications such as medicine, the financial industry, or industrial monitoring systems. While there are a variety of methods for post hoc explanation of model results for tabular and image-based data, the number of such methods for time-series data is comparatively low. In particular, the majority of existing methods focus on classification tasks, while no explanation methods specifically designed for anomaly detection in time series are yet known.

The existing methods for explainability of time series models can be divided into different categories. Gradient-based methods weight the importance of individual time points based on the magnitude of the gradient in a neural network, but are limited to differentiable deep learning models. Example-based methods explain time series by comparing them to a representative curve, such as a so-called shapelet, but this method is highly dependent on the availability of suitable representatives and can be very computationally intensive. Another option is perturbation-based methods, in which portions of the input data are masked or altered to analyze their impact on the prediction. However, this technique is particularly challenging in the case of time series, as the manipulation of individual segments often leads to artificial anomalies, which may impair the validity of the explanation.

The challenges in explainability of time series models, particularly in the area of anomaly detection, make it clear that previous methods are reaching their limits and that new approaches are required to enable reliable and interpretable analysis of model decisions in this area.

It is therefore a problem addressed by the disclosure to provide an improved method and/or an improved device, in particular for time series analysis.

The problem is solved with a method according to the features set forth below. The problem is solved by an apparatus also according to the features set forth below.

### SUMMARY

According to a first aspect, a method for explaining an anomaly in a time series of a manufacturing process, at least within a predetermined time window, is proposed, wherein the anomaly is detected by way of a detection model. The method comprises the steps of: providing anomaly-free sample time series of the manufacturing process as well as the time series to be explained; determining a nearest neighbor from the anomaly-free sample time series for the potentially, at least in sections, anomalous time series to be explained by way of a nearest-neighbor algorithm; determining a linear functional component between a function value of the time series to be explained at a time window start of the time window and a function value of the time series to be explained at a time window end of the predetermined time window by way of linear interpolation; ascertaining a residual component function for the nearest neighbor between the time window start and the time window end; replacing a functional section of the time series to be explained within the time window using the linear functional component and the residual component function to generate a replaced time series within the time window; calculating an anomaly score for the replaced time series within the time window by way of the detection model; comparing the anomaly score of the replaced time series within the time window with an anomaly score of the time series to be explained within the time window, which score is calculable by way of the detection model, to generate an explainability curve for the anomaly within the time window; and optionally, performing an action within the manufacturing process using the explainability curve.

A “time series” to be explained preferably refers to a sequence of measured values over time that is analyzed to identify deviations or patterns.

The method preferably comprises the step of providing anomaly-free sample time series of the manufacturing process as well as the time series to be explained, preferably wherein “anomaly-free” means that the time series do not contain any discernible deviations or undesirable disruptions. Alternatively, “disturbance-free sample time series” or “referenced sample time series” could be used.

A further step preferably comprises determining a nearest neighbor from the anomaly-free sample time series for the potentially, at least in sections, anomalous time series to be explained by way of a nearest-neighbor algorithm. A “nearest-neighbor algorithm” preferably refers to a method of machine learning or pattern recognition, in which the similarity between data sets is determined based on a distance metric. When searching for the nearest neighbor, preferably the elements between the window start and the window end are weighted, such that they do not contribute to the search for the nearest neighbor. This mitigates potential information leaks.

Furthermore, a linear functional component is preferably determined between a function value of the time series to be explained at a time window start and a function value of the time series to be explained at a time window end by way of linear interpolation. “Linear interpolation” preferably refers to a mathematical method for calculating intermediate values between two known points based on a straight connecting line.

Finally, a residual component function is preferably ascertained for the nearest neighbor between the time window start and the time window end. The “residual component function” preferably refers to the difference between the actual time-series function and the determined linear functional component in order to make remaining patterns or deviations visible. Alternatively, it could be referred to as a “difference function” or a “deviation component.” The technical advantage is preferably that nonlinear deviations and patterns can be viewed in isolation and further analyzed in order to specifically identify anomalies.

In the functional section replacement or imputation step, the linear component within the window is preferably retained, and only the nonlinear residual within the time window is replaced by the corresponding values of the functional section of the nearest neighbor.

For example, the action may comprise adjusting a process parameter of the manufacturing process or altering a manufacturing condition.

Alternatively, or in addition, the method may also be used for classification tasks. In that case, a method for explaining a classification of a time series of a manufacturing process is then proposed at least within a predetermined time window, wherein the classification is determined by way of a classification model. The method comprises the steps of: providing correctly classified sample time series of the manufacturing process as well as the potentially incorrectly classified time series to be explained; determining a nearest neighbor from the sample time series for the time series to be explained by way of a nearest-neighbor algorithm; determining a linear functional component between a function value of the time series to be explained at a time window start of the time window and a function value of the time series to be explained at a time window end of the predetermined time window by way of linear interpolation; ascertaining a residual component function for the nearest neighbor between the time window start and the time window end; replacing a functional section of the time series to be explained within the time window using the linear functional component and the residual component function to generate a replaced time series within the time window; calculating a classification probability for the replaced time series within the time window by way of the classification model; comparing the classification probability of the replaced time series within the time window with a classification probability of the time series to be explained within the time window, which probability is calculable by way of the classification model, to generate an explainability curve for the classification within the time window; and optionally, performing an action within the manufacturing process using the explainability curve. The same embodiments also apply analogously to a corresponding device.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, a device for explaining an anomaly in a time series of a manufacturing process at least within a time window is proposed, wherein the anomaly is detectable by way of a detection model, wherein the device comprises an evaluation and computation device configured to perform the following steps: providing anomaly-free sample time series of the manufacturing process as well as the time series to be explained; determining a nearest neighbor from the anomaly-free sample time series for the potentially, at least in sections, anomalous time series to be explained by way of a nearest-neighbor algorithm; determining a linear functional component between a function value of the time series to be explained at a time window start of the time window and a function value of the time series to be explained at a time window end of the predetermined time window by way of linear interpolation; ascertaining a residual component function for the nearest neighbor between the time window start and the time window end; replacing a functional section of the time series to be explained within the time window using the linear functional component and the residual component function to generate a replaced time series within the time window; calculating an anomaly score for the replaced time series within the time window by way of the detection model; comparing the anomaly score of the replaced time series within the time window with an anomaly score of the time series to be explained within the time window, which score is calculable by way of the detection model, to generate an explainability curve for the anomaly within the time window; and optionally, performing an action within the manufacturing process using the explainability curve.

The explanations given for the method apply to the apparatus accordingly. In this regard, any linguistic modifications of features formulated in terms of the method can be reformulated for the apparatus in accordance with standard linguistic practice, without such formulations having to be explicitly listed here.

The method preferably uses a nearest-neighbor search for the time series to be explained in order to determine time-series instances that are as similar as possible to the time series to be explained and that are close to the time series to be examined, but for which it is known that they do not exhibit an anomaly or are not incorrectly classified. This nearest neighbor is then used for replacing the functional section or for the imputation. For this purpose, a collection of sample time series or time-series instances is preferably required that covers the data distribution of non-anomalous or correctly classified time series as comprehensively as possible for any variations of the manufacturing process.

The disclosure describes the importance of each time step of a time series for the prediction of an ML model. More specifically, the disclosure describes a novel perturbation-based technique for calculating importance scores in the time domain of a one-dimensional or multidimensional time series. In particular, the disclosure may be used to explain the anomaly score generated by an ML model for anomaly detection by highlighting anomalous segments of the time series. Compared to existing methods, the disclosure has several advantages. The disclosure is one of the first explanatory methods specifically designed for the detection of time-series anomalies. Like other perturbation-based techniques, the disclosure assumes that the ML model is a black box and thus may be used to explain a variety of models. Furthermore, the disclosure may provide a quantifiable explanation for each time step. In contrast to existing methods, the disclosure generates an importance value for each measurement in a time series. Furthermore, the disclosure enables noninvasive occlusion or imputation. The disclosure preferably comprises a new imputation technique that avoids the introduction of artificial anomalies, which to date represents a significant limitation of existing perturbation-based techniques. In particular, the disclosure retains a linear component of a window during the imputation step, thereby preferably avoiding artificial jumps in the imputed time series. Such jumps would typically themselves be highly anomalous and would therefore lead to unreliable or false explanations.

The disclosure may be used to explain predictions for one-dimensional or multidimensional time-series instances of any time-series classification and/or anomaly detection model. In particular, the disclosure may be used to identify and evaluate anomalous segments in a manufacturing process curve. For example, experts can locate anomalies within a process curve, which allows them to better understand the cause of an anomaly and/or distinguish between different types of failures.

The disclosure can preferably be used to analyze data captured by a sensor. The sensor may preferably determine measured values from the environment in the form of sensor signals, wherein these signals may preferably serve for further use. In the area of virtual sensors, the disclosure may preferably obtain information about elements encoded by the signal on the basis of the sensor signal, so that an indirect measurement can be made. In addition, the disclosure may preferably generate a new signal indicative of the importance of each measurement in the original time series for the prediction. In the area of anomaly detection, the disclosure may preferably be used to map instance-based anomaly scores to the time domain. It preferably does not calculate its own anomaly scores, but rather quantifies the importance of each time point for the anomaly score of an anomaly detection model. Furthermore, the disclosure may preferably be used for training anomaly-type clustering by clustering the importance values to identify anomaly-type groups, for example, anomalies at the beginning or in the middle phase of a time period. Furthermore, the disclosure may preferably be used to generate synthetic data by identifying conspicuous segments, which may preferably be inserted into other instances to generate artificial data sets.

In a further respect, it is proposed that steps S2 to S7 are repeated for a plurality of window positions of the time window over the time series to be explained, in particular until the entire time series to be explained is analyzed.

Particularly preferably, the present method is iteratively repeated until the entire time series has been analyzed and thus made explainable. The analysis is preferably performed for all possible window positions of the predetermined time window. The iteratively reviewed time windows may overlap, for example. In order to thereby avoid errors in the explainability curve, it is preferred that a mean of the corresponding score differences is calculated for the final explainability curve. Alternatively or in addition, the time series or process curve can also be divided into multiple, non-overlapping time windows. This can save computational time and increase efficiency over a classical sliding window approach.

In a further aspect, it is proposed that the provided anomaly-free pattern time series are each cluster representations of a plurality of anomaly-free pattern time series determined from the plurality of anomaly-free pattern time series by way of a clustering method.

A “cluster representation” preferably refers to a summary representation or a representative prototype of a cluster derived from a group of similar data points. The technical advantage is preferably that a compact and efficient data structure is created that reduces the variety of anomaly-free pattern time series while still preserving essential properties.

These cluster representations are preferably determined from the plurality of anomaly-free pattern time series by way of a clustering method. A “clustering method” preferably refers to a method of machine learning or data analysis, in which data sets are divided into groups or clusters based on similarity criteria. The technical advantage is preferably that data-driven and scalable structuring of the anomaly-free pattern time series is made possible, thereby achieving more efficient processing and a more robust comparison to new time series.

Thus, a plurality of pattern time series, e.g., 1000 pattern time series, need not be pre-stored, but only one time series representing each time series cluster is stored as the pattern time series, in order to compare these with the, potentially anomalous, time series to be explained or examined via the nearest-neighbor algorithm.

In another aspect, it is proposed that the clustering method comprises a k-medoids clustering method.

The “k-medoids clustering method” preferably refers to an algorithmic method for cluster formation in which, instead of the arithmetic mean as is the case with k-means, actual existing data points are selected as cluster centers (medoids). Alternatively, one could speak of a “medoid-based cluster analysis” or a “representative grouping strategy”.

The advantage is preferably that by selecting real time series as cluster centers, better interpretability and robustness against outliers is achieved. In addition, comparability with new time series is improved because the cluster representations are actual time series from the original data and thus provide greater relevance to the anomaly detection process. Unlike k-means, the centroids of a k-medoids model correspond to the actual data points in the training set. Accordingly, the present disclosure ensures that values or functional sections are imputed with functional values lying within the actual data distribution.

In another aspect, it is proposed that at least the time series to be explained is captured by a sensor during the manufacturing process.

Capturing is preferably performed by a sensor, wherein a “sensor” is a technical component that measures physical or chemical quantities and converts them into digital or analog signals. The measurement is preferably performed during the manufacturing process, meaning that the data acquisition is directly related to the production operations. The technical advantage is preferably that anomalies can be detected during production, thereby enabling early fault detection and a rapid response to avoid scrap or production disruptions.

In another aspect, it is proposed that the time window size be changed multiple times during the analysis of the time series to be explained.

In order to explain a given time series instance, the disclosure imputes segments of the time series in a windowing scheme. The window imputation is performed several times for different window sizes.

The time window size is preferably changed multiple times during the analysis of the time series to be explained. The “time window size” preferably refers to the length of a selected section of the time series, within which analysis or processing is performed. In order to explain a given time series instance, the disclosure preferably imputes segments of the time series in a windowing scheme. “Imputation” preferably refers to the addition or completion of missing or incomplete data by way of algorithmic methods. The window imputation is preferably performed several times for different window sizes. A “windowing scheme” preferably describes a systematic approach for decomposing a time series into overlapping or non-overlapping sections for further analysis. Alternatively, this may be called “segment-based analysis” or “section-by-section processing”.

In a further aspect, it is proposed that the detection model comprises a neural network or a tree-based model or a linear model.

A “detection model” preferably refers to a mathematical or algorithmic method for identifying patterns or anomalies in a time series.

A neural network is preferably employed as a detection model, whereby a “neural network” designates an architecture structured by artificial neurons for processing and pattern recognition in complex data.

Alternatively, the detection model may preferably be a tree-based model. A “tree-based model” preferably refers to a class of algorithms that use decision structures in the form of branches and nodes to perform predictions or classifications.

Additionally or alternatively, a linear model may preferably be used as a detection model. A “linear model” preferably refers to a mathematical regression or classification method that establishes linear relationships between input and output variables.

In a further aspect, a control unit is also described which is comprised in a vehicle having an autonomous driving function and/or a robotic system and/or an industrial machine, and on which the present method is executable in one of its aspects.

In a further aspect, a computer program comprising program code is described for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The disclosure thus preferably provides a perturbation-based explanation method for time series. Like tabular explanation methods (e.g., LIME), these methods preferably quantify the importance of elements of a data input, preferably in the present case the measurements over time, by masking portions of the input and observing a change in the model result. For example, if a time series window with an expected OK segment is imputed and the anomaly value is recalculated, the impact of the imputed window on the original anomaly value can be investigated. If the anomaly value becomes smaller after a particular window has been imputed, that window likely comprises an anomaly.

The difficulty is to impute a window with a meaningful, expected OK value without generating artificial anomalies. Existing explanation methods for classification often impute an arbitrary value (e.g., zero). However, in classification, the value used for the imputation is not so critical. As long as one is able to mask the features of the predicted class, the class probability is reduced regardless of the value, with which the time series is masked. When explaining anomaly detection, on the other hand, the goal of imputation is to reduce the anomaly score. Thus, it is preferred that the time series does not become more anomalous due to the imputation step, which can easily happen, particularly when using the naive processes of existing methods. For example, imputing a window with 0 generally results in non-differentiable breaks in the time series that are identified as an anomaly by any reliable anomaly detection model. However, this renders the explanation useless.

The described embodiments and refinements may be combined with one another as desired.

Further possible embodiments, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings.

The illustrated elements of the drawings are not necessarily shown to scale with respect to one another.

FIG. 1 shows a schematic flowchart of an exemplary method.

FIG. 2 shows a schematic representation of the method using time series.

FIG. 3 shows a time series from a manufacturing process with an anomaly.

FIG. 4 shows an explainability curve for the time series known from FIG. 3, determined by way of the present method.

### DETAILED DESCRIPTION

In the figures of the drawings, identical reference numbers denote identical or functionally identical elements, parts or components, unless stated otherwise.

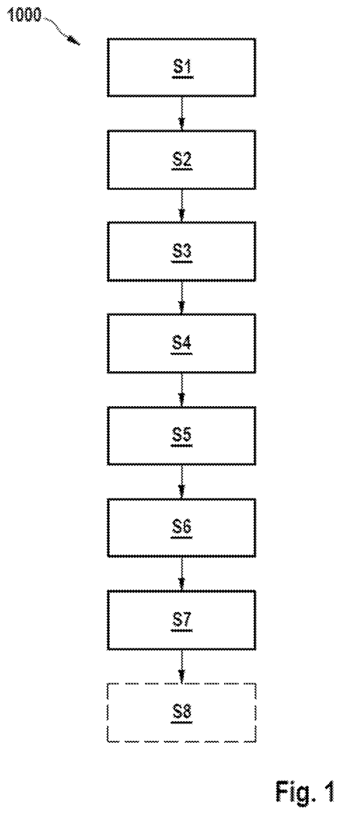

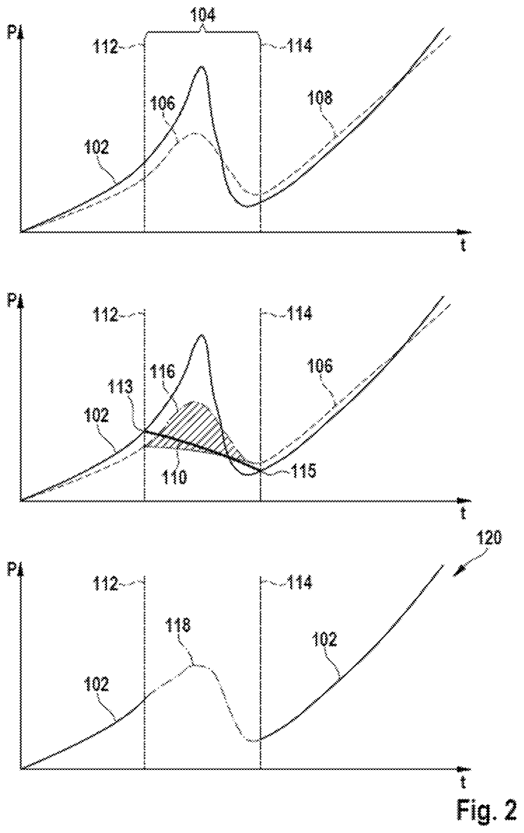

The method as well as the device are explained with reference to all FIGS. 1 to 4, without the figures being addressed separately in each case.

FIG. 1 shows a schematic flow chart of a method for explaining an anomaly 100 in a time series 102 of a manufacturing process at least within a time window 104. The time series 102 may depict any process variable P of the manufacturing process over time t, wherein the process variable P is measurable with, for example, at least one sensor.

The method can be carried out in any embodiment, at least in part, by a device 1000 which may comprise several components not shown in detail, for example one or more provision devices and/or at least one evaluation and calculation unit. It is understood that the provision device may be configured together with the evaluation and calculation unit or may be separate from it. Furthermore, the device 1000, which may be part of a system, may comprise a storage device and/or an output device and/or a display device and/or an input device.

The computer-implemented method comprises at least the following steps:

In a step S1, anomaly-free pattern time series 106 of the manufacturing process as well as the time series 102 to be explained are provided.

In a step S2, a nearest neighbor 108 is determined from the anomaly-free pattern time series 106 for the time series 102 to be explained by way of a nearest-neighbor algorithm.

In a step S3, a linear functional component 110 between a function value 113 of the time series 102 to be explained at a time window start 112 of the time window 104 and a function value 115 of the time series 102 to be explained at a time window end 114 of the predetermined time window 104 is determined by way of linear interpolation.

In a step S4, a residual component function 116 is ascertained for the nearest neighbor 108 between the time window start 112 and the time window end 114.

In a step S5, a functional section 118 of the time series 102 to be explained within the time window 104 is replaced using the linear functional component 108 and the residual component function 116 to generate a replaced time series 120 within the time window 104.

In a step S6, an anomaly score for the replaced time series 120 within the time window 104 is calculated by way of the detection model.

In a step S7, the anomaly score of the replaced time series within the time window 104 is compared with an anomaly score of the time series 102 to be explained within the time window 104, which score is calculable by way of the detection model to generate an explainability curve 122 for the anomaly 100 within the time window 104.

In a purely optional step S8, an action within the manufacturing process is performed using the explainability curve 122.

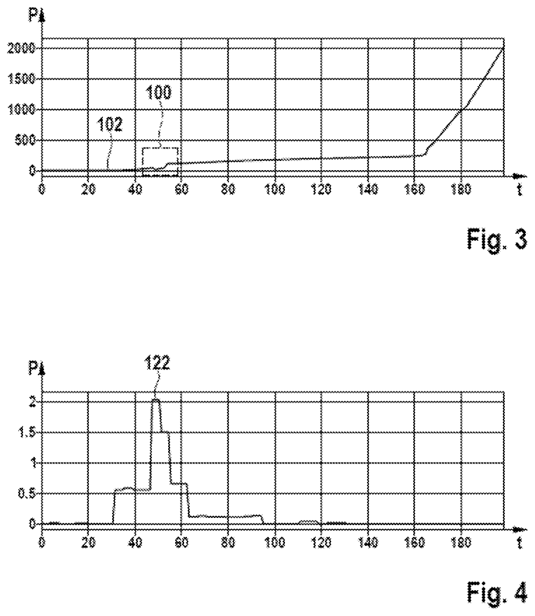

According to FIGS. 3 and 4, the present method has been used to generate the explainability curve 122 for a known time series with an anomaly, indicating the importance of each time step for the obtained anomaly score. High values of the explainability curve 122 preferably indicate that a segment within the time series 102 to be explained contributed more to the anomaly score. The explanation successfully highlights the time steps corresponding to the known anomaly 100, as shown in FIGS. 3 and 4.

What is claimed is:

1. A method for explaining an anomaly in a time series to be explained of a manufacturing process at least within a time window, wherein the anomaly is detected by way of a detection model, the method comprising:
(S1) providing anomaly-free pattern time series of the manufacturing process as well as the time series to be explained;
(S2) determining a nearest neighbor from the anomaly-free pattern time series for the time series to be explained by way of a nearest-neighbor algorithm;
(S3) determining a linear functional component between a function value of the time series to be explained at a time window start of the time window and a function value of the time series to be explained at a time window end of the predetermined time window by way of linear interpolation;
(S4) ascertaining a residual component function for the nearest neighbor between the time window start and the time window end;
(S5) replacing a functional section of the time series to be explained within the time window using the linear functional component and the residual component function to generate a replaced time series within the time window;
(S6) calculating an anomaly score for the replaced time series within the time window by way of the detection model; and
(S7) comparing the anomaly score of the replaced time series within the time window with an anomaly score of the time series to be explained within the time window, which score is calculable by way of the detection model to generate an explainability curve for the anomaly within the time window.

2. The method according to claim 1, wherein steps S2 to S7 are repeated for a plurality of window positions of the time window over the time series to be explained until the entire time series to be explained is analyzed.

3. The method according to claim 1, wherein the provided anomaly-free pattern time series are each cluster representations of a plurality of anomaly-free pattern time series determined from the plurality of anomaly-free pattern time series by way of a clustering method.

4. The method according to claim 1, wherein the clustering method comprises a k-medoids clustering method.

5. The method according to claim 1, wherein the time window size is changed multiple times during the analysis of the time series to be explained.

6. The method according to claim 1, wherein at least the time series to be explained is captured by a sensor during the manufacturing process.

7. The method according to claim 1, wherein the detection model comprises a neural network or a tree-based model or a linear model.

8. A computer program with program code to execute at least portions of the method according to claim 1 when the computer program is executed on a computer.

9. A computer-readable data carrier with program code of a computer program to execute at least portions of the method according to claim 1 when the computer program is executed on a computer.

10. A device for explaining an anomaly in a time series of a manufacturing process at least within a time window, wherein the anomaly is detectable by way of a detection model, and wherein the device comprises an evaluation and computation device configured to perform the following:
providing anomaly-free pattern time series of the manufacturing process as well as the time series to be explained;
determining a nearest neighbor from the anomaly-free pattern time series for the time series to be explained by way of a nearest-neighbor algorithm;
determining a linear functional component between a function value of the time series to be explained at a time window start of the time window and a function value of the time series to be explained at a time window end of the predetermined time window by way of linear interpolation;
ascertaining a residual component function for the nearest neighbor between the time window start and the time window end;
replacing a functional section of the time series to be explained within the time window using the linear functional component and the residual component function to generate a replaced time series within the time window;
calculating an anomaly score for the replaced time series within the time window by way of the detection model, and
comparing the anomaly score of the replaced time series within the time window with an anomaly score of the time series to be explained within the time window, which score is calculable by way of the detection model to generate an explainability curve for the anomaly within the time window.

11. The device according to claim 10, wherein the evaluation and computation device is further configured to perform the following:
an action within the manufacturing process using the explainability curve.

12. The method according to claim 1, further comprising:
performing an action within the manufacturing process using the explainability curve.

13. A computer program with program code to execute the method according to claim when the computer program is executed on a computer.

14. A computer-readable data carrier with program code of a computer program to execute the method according to claim 1 when the computer program is executed on a computer.
